(19) United States
(12) Patent Application Publication
(10) Pub. No.: US 2005/0017619 A1
(43) Pub. Date: Jan. 27, 2005

(54) Modified high-brightness flat lamp structure

(76) Inventors: Sheng-Chih Wan, Hsinchu Hsuan (TW); Shen-Chun Wu, Hsinchu Hsuan (TW); Chung-Cheng Liu, Hsinchu Hsuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/622,732

(22) Filed: Jul. 21, 2003

(51) Int. Cl. H01J 5/16; H01K 1/26; H01J 61/40; H01K 1/30

(52) U.S. Cl. 313/112

(57) ABSTRACT

A modified high-brightness flat lamp structure comprises a reflecting plate, a plurality of UV light sources and a transparent substrate. The reflecting plate has titanium dioxide and macromolecular polymer coated thereon. The transparent substrate has macromolecular polymer and fluorescent powder coated thereon. The UV light sources are arranged in the reflecting plate. The transparent substrate covers the reflecting plate. UV light emitted by the UV light sources and reflected by the reflecting plate will thus excite the fluorescent powder layer to radiate high-brightness visible light.

### FIELD OF THE INVENTION

The present invention relates to a flat lamp and, more particularly, to a flat lamp of a simple structure and formed with easy manufacturing processes, which has a uniform color temperature and a high brightness.

### BACKGROUND OF THE INVENTION

A conventional cold cathode fluorescent flat lamp (CCFFL) comprises several UV lamps with fluorescent powder coated on inner walls thereof. A high voltage is applied across the electrodes thereof to generate UV light which strikes the fluorescent powder to form visible light. In a CCFFL disclosed in R.O.C. Pat. No. 495,796, after a chamber is vacuumed, noble gas and mercury vapor are filled therein, and a high voltage is then applied across the cathode and anode thereof through a circuit board to generate UV light which strikes fluorescent powder coated on the inner wall of the chamber to form visible light. However, because of residual organic solvent, the situation of burned black will occur at the electrodes of the CCFFL after a longtime use, hence seriously affecting the light emission efficiency. Therefore, how to manufacture a flat lamp which can be used for a long time without affecting the light emission efficiency becomes a problem to be solved urgently by the display and lamp industry.

### SUMMARY AND OBJECTS OF THE PRESENT INVENTION

The primary object of the present invention is to provide a high-brightness flat lamp with fluorescent powder coated on a transparent substrate thereof so as to avoid the situation of burned black at the electrodes of conventional CCFFL after a longtime use and thus solve the problem of low light emission efficiency.

Another object of the present invention is to provide a high-brightness flat lamp of simple manufacturing process so as to provide a manufacturing process of easy mass production and high yield for the industry.

To achieve the above objects, the present invention provides a modified high-brightness flat lamp structure, which comprises a reflecting plate with titanium dioxide and macromolecular polymer coated thereon, a plurality of UV light sources and a transparent substrate with macromolecular polymer and fluorescent powder coated thereon. The UV light sources are arranged in the reflecting plate. The transparent substrate then covers the reflecting plate. UV light emitted by the UV light sources and reflected by the reflecting plate will thus excite the fluorescent powder layer to radiate high-brightness visible light.

The various objects and advantages of the present invention will be more readily understood from the following detailed description when read in conjunction with the appended drawings, in which:

### BRIEF DESCRIPTION OF DRAWING

FIG. 1 is a perspective view of the present invention;

FIG. 2a is a front view of the present invention;

FIG. 2b is a front view according to another embodiment of the present invention; and

FIG. 3 is a diagram showing light emission of the present invention.

### DETAILED DESCRIPTION OF PREFERRED EMBODIMENT

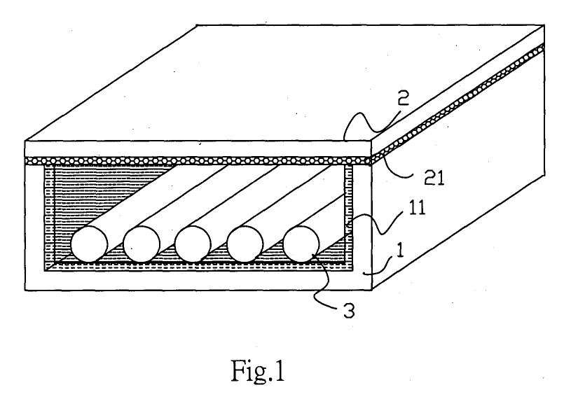

As shown in FIG. 1, a high-brightness flat lamp of the present invention has a cavity-shaped reflecting plate 1. Titanium dioxide and macromolecular polymer 11 is coated on the inner wall of the reflecting plate 1 so that the inner wall of the reflecting plate 1 can reflect UV light. Next, UV light sources 3 are arranged in the reflecting plate 1 so that UV light emitted by the UV light sources 3 can illuminate the inner wall of the reflecting plate 1. The UV light sources 3 can be any light sources capable of emitting UV light, and are preferred to be UV lamp tubes and UV light-emitting diodes (LEDs). Finally, a transparent substrate 2 with macromolecular polymer and fluorescent powder 21 coated at the inner or outer layer thereof covers the opening of the cavity-shaped reflecting plate 1 so that UV light can excite the fluorescent powder on the transparent substrate 2 to radiate visible light. The material of the transparent substrate 2 is not limited, and is preferred to be plastic and glass. The plastic material is preferred to be polymethyl methacrylate (PMMA), polyethylene terephthalate (PET) or polycarbonate (PC). The glass material is preferred to be quartz glass, sodium-containing glass, lead-sodium-silicate glass or boron-containing silicate glass.

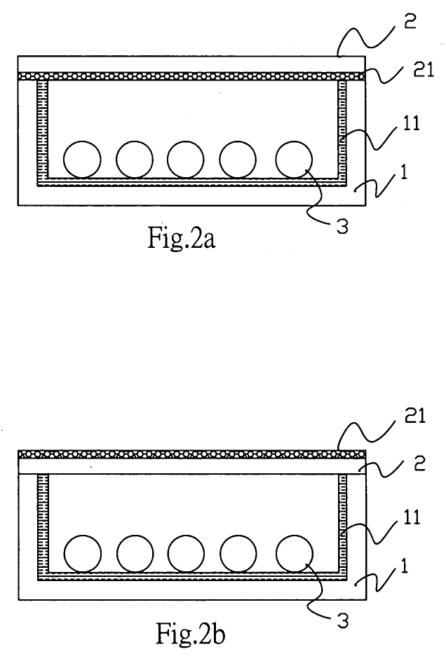

FIGS. 2a and 2b show different structures of the present invention with the macromolecular polymer and fluorescent powder 21 coated at the inner and outer layer of the transparent substrate 2, respectively. When the transparent substrate 2 has a limited thickness, the light emission efficiencies thereof differ little.

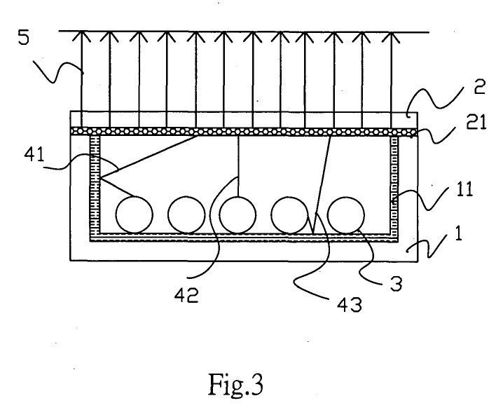

As shown in FIG. 3, when the UV light sources 3 radiate UV light 41, 42 and 43, there will be the following situations between the UV light 41, 42 and 43, the reflecting plate 1 and the transparent substrate 2.
(1) After the UV light 41 is emitted by the UV light sources 3 and reflected by the titanium dioxide and macromolecular polymer 11 on the sidewall of the reflecting plate 1, it will be incident into the transparent substrate 2 and excite the macromolecular polymer and fluorescent powder 21 to radiate visible light 5;
(2) After the UV light 42 is emitted by the UV light sources 3, it will be directly incident into the transparent substrate 2 and excite the macromolecular polymer and fluorescent powder 21 to radiate visible light 5;
(3) After the UV light 43 is emitted by the UV light sources 3 and reflected by the titanium dioxide and macromolecular polymer 11 at the bottom of the reflecting plate 1, it will be incident into the transparent substrate 2 and excite the macromolecular polymer and fluorescent powder 21 to radiate visible light 5.

Therefore, the macromolecular polymer and fluorescent powder 21 on the transparent substrate 2 will be excited by the UV light 41, 42 and 43 from all directions to radiate uniform planar visible light 5.

To sum up, the present invention can save the vacuum process required for manufacturing conventional CCFFLs. Moreover, because fluorescent powder is coated at the inner or outer layer of the transparent substrate 2 instead the inner wall of CCFFLs, the manufacturing process and the assembly will be simpler and more convenient. Besides, because UV light are uniformly reflected in all directions by the cavity-shaped reflecting plate 1, they can excite fluorescent powder coated on the transparent substrate 2 to radiate uniform planar visible light.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A modified high-brightness flat lamp structure comprising:
a reflecting plate having a cavity formed therein, said cavity having a longitudinally extended bottom wall bounded by a plurality of sidewalls with titanium dioxide and a macromolecular polymer coated thereon;
a plurality of UV light sources disposed in said cavity in side by side longitudinally spaced relationship; and,
a transparent substrate having opposing inner and outer walls, said inner wall being disposed in overlaying relationship with said reflecting plate, said transparent substrate forming a closure for said cavity and being coated with a macromolecular polymer and fluorescent powder, wherein UV light emitted by said UV light sources is reflected by said reflecting plate for exciting said fluorescent powder to radiate high-brightness visible light from said outer wall of said transparent substrate.

2. The flat lamp structure as claimed in claim 1, wherein said titanium dioxide and macromolecular polymer is coated on respective inner surfaces of said bottom wall and said sidewalls of said cavity.

3. The flat lamp structure as claimed in claim 1 and 2, wherein said reflecting plate is a reflecting plate capable of reflecting UV light.

4. (Cancelled).

5. The flat lamp structure as claimed in claim 1, wherein said macromolecular polymer and fluorescent powder is coated on said inner wall of said transparent substrate.

6. The flat lamp structure as claimed in claim 1, wherein said macromolecular polymer and fluorescent powder is coated on said outer wall of said transparent substrate.

7. The flat lamp structure as claimed in claim 1, wherein said UV light sources are UV lamp tubes.

8. The flat lamp structure as claimed in claim 1, wherein said UV light sources are UV light-emitting diodes.

9. The flat lamp structure as claimed in claim 1, wherein said transparent substrate is made of polymethyl methacrylate (PMMA).

10. The flat lamp structure as claimed in claim 1, wherein said transparent substrate is made of polycarbonate (PC).

11. The flat lamp structure as claimed in claim 1, wherein said transparent substrate is made of polyethylene terephthalate (PET).

12. The flat lamp structure as claimed in claim 1, wherein said transparent substrate is made of quartz glass.

13. The flat lamp structure as claimed in claim 1, wherein said transparent substrate is made of sodium-containing glass.

14. The flat lamp structure as claimed in claim 1, wherein said transparent substrate is made of boron-containing silicate glass.

15. The flat lamp structure as claimed in claim 1, wherein said transparent substrate is made of lead-sodium-silicate glass.
